(19) United States
(12) Patent Application Publication
(10) Pub. No.: US 2026/0317157 A1
(43) Pub. Date: Oct. 15, 2026

(54) TINTING MACHINE

(71) Applicant: Davis OSWALD, Maharashtra (IN)

(72) Inventor: Davis OSWALD, Maharashtra (IN)

(21) Appl. No.: 19/111,102

(22) PCT Filed: Jul. 27, 2023
(86) PCT No.: PCT/IB2023/057632

§ 371 Date: Mar. 12, 2025

(30) Foreign Application Priority Data
Sep. 12, 2022 (IN) 202221052046

(51) Int. Cl. B67D 7/84; B67D 7/02; B67D 7/62; B67D 7/74

(52) U.S. Cl. CPC B67D 7/84; B67D 7/02; B67D 7/62; B67D 7/74

(57) ABSTRACT

The present disclosure relates to a tinting machine (100) comprising pumps (104) in fluid communication with canisters (102) storing colorants. The pump (104) comprises a housing (202) with an inlet port (104-1) and an output port (104-2). The pump (104) has a stator (204), and a rotor (206) rotatably configured in the stator (204). The rotor (206) and the stator (204) are in D45 geometry configuration, where the rotor (206) has a helical eccentric shape and an elliptical cross-section, and the stator (204) has an internal thread with 120 degrees interval triple starts and 1.5 times pitch, which creates a two/three ratio lobe geometry, thereby creating cavities between the rotor (206) and stator (204), such that rotation of the rotor (206) within the stator (204) enables inflow of the fluid from the canister (104) into the pump (104) and further enables dispensing of the fluid through the output port (104-2).

### TECHNICAL FIELD

The present disclosure relates to the field of tinting machines. More particularly the present disclosure relates to an improved and compact pump for tinting machines, which produces a higher flow rate and higher pumping pressure while occupying less space and reducing the size and manufacturing cost of the pump as well as the tinting machine.

### BACKGROUND

Background description includes information that may be useful in understanding the present disclosure. It is not an admission that any of the information provided herein is prior art or relevant to the presently claimed disclosure, or that any publication specifically or implicitly referenced is prior art.

Progressive cavity pumps are capable of handling a wide range of fluids. They develop their pumping action through the meshing of the internal threads of the stator and the external thread of the rotor. The stator has a certain thickness and is placed inside a tube. The rotor is inserted in the stator that has a helical structure. The stator and rotor have a special geometry with varying pitches of stator and rotor threads to create displacement chambers that produce a constant flow against the differential pressure in the pump. The rotor makes contact with the stator to form a series of cavities that lifts the fluid along the axis of the pump outlet. The transport of fluid is achieved through a hydrostatic displacement of a defined volume of fluid. The discharge of fluid is based on the interaction between the stator and the rotating rotor. Currently, S and L geometry configuration progressive cavity pumps are being used in the tinting machines. These pumps have a rotor with a circular cross-section which oscillates in the rotor with 180 degrees twin starts and twice the pitch of the stator. The flow rate is determined by the pitch of the rotor, the pitch of the stator, their diameter, eccentricity, and the pumping speed. The pressure capability depends upon the number of stages.

Existing progressive cavity pumps employing S/L pump geometry configurations are used in tinting machines for dispensing colorant (fluid). The S/L pump geometry configuration pump can reach differential pressures up to 12 bar at a 100 percent flow rate. However, these pumps are extensive in size that occupy larger space, and increase the cost of the pump. As a result, the overall size and manufacturing cost of the tinting machine also increases as a multiple numbers of such pumps are employed in a single tinting machine.

There is, therefore, a need to overcome the above drawback, limitations, and shortcomings associated with the existing configuration of progressive cavity pumps and provide an improved and compact progressive cavity pump for tinting machines, which provides a higher flow rate and higher pumping pressure, while occupying less space and reducing the overall size and manufacturing cost of the pump as well as the tinting machine.

### OBJECTS OF THE PRESENT DISCLOSURE

Some of the objects of the present disclosure, which at least one embodiment herein satisfies are as listed herein below.

It is an object of the present disclosure to overcome the above drawback, limitations, and shortcomings associated with existing S and L-type geometry-based pumps.

It is an object of the present disclosure to reduce the size of pumps used in tinting machines, without compromising on the overall performance of the pump and tinting machine.

It is an object of the present disclosure to provide a pump geometry configuration that produces a higher flow rate and higher pumping pressure and has higher accuracy while dispensing fluids, ensuring efficient operation.

It is an object of the present disclosure to provide a pump geometry configuration that reduces the overall size and manufacturing cost of the pump as well as the tinting machine.

It is an object of the present disclosure to provide an improved and compact pump for tinting machines, which produces a higher flow rate and higher pumping pressure while occupying less space and reducing the size and manufacturing cost of the pump as well as the tinting machine.

### SUMMARY

This present disclosure relates to an improved and compact pump for tinting machines, which produces a higher flow rate and higher pumping pressure while occupying less space and reducing the size and manufacturing cost of the pump as well as the tinting machine.

In an aspect, the present disclosure pertains to a tinting machine with an improved and compact pump is disclosed. The tinting machine has a frame supporting canisters attached with their corresponding pumps for dispensing the stored fluid (colorants) into a base can or a container that is already filled with a white base. The output ports of each of the pumps of the tinting machine are configured with a dispensing tube. Further, a nozzle may be provided on each of the dispensing tubes to dispense the colorant in the can base.

The pump has a housing comprising an inlet port and an outlet port, where the inlet port is connected to the outlet of the corresponding canister. The pump has a stator configured in the housing. Further, a rotor is movably configured in the stator and connected to a stepper motor. The fluid is dispensed through the outlet port of the pump. The stator and rotor are in a D45 geometry that provides cavities between the stator and the rotor. The rotor rotates in a circular eccentric motion within the stator, which allows the cavities to enable inflow of the fluid from the canister into the pump and further enables dispensing of the fluid through the outlet port.

The helical eccentric rotor of the pump with the D45 geometry is made up of steel and has an elliptical cross-section. It turns in a circular eccentric motion with the fixed stator, which has an internal thread, but with 120-degree interval triple starts and 1.5 times the pitch. As the result of this two/three ratio lobe geometry, cavities are formed between the stator and the rotor. When the rotor turns within the stator, the cavities formed between them enable the inflow of the fluid from the inlet port and dispense the fluid through the outlet port of the pump. The flow rate is determined by the pitch of the stator/rotor, the elliptical diameter as well as the pumping rotation speed. Further, a seal is configured at a connecting region between the stator and rotor in the pump that allows the rotation of the rotor and restricts leakage of the fluid from the housing,

In an aspect, a stepper motor may be coupled to the rotor of each of the pumps, which rotates the rotor within the stator causing the fluid to dispense from the corresponding pump. One stepper motor may be individually coupled to the rotor of each pump through a coupling assembly. A coupling disc and a set of couplings may be configured between the rotor and a seal for assistance in rotation. Additionally, a bottom coupling with a flange and a washer may be configured for assistance in rotation between the seal and the rotor. The seal can be a mechanical seal or any other seal known in the art.

In an aspect, a control unit may be configured with the stepper motor for each of the pumps. The control unit may control and enable the independent actuation of the stepper motors and the corresponding pumps. This may result in controlled dispensing of a predefined amount of the fluid from the outlet port of the corresponding pumps.

In an aspect, the tinting machine may be configured with a stirrer assembly in each of the canisters that enable the stirring of the fluid in the canister. The stirrer assembly may have a set of stirrer panels connected to a longitudinal member in each of the canisters. This may enable adequate stirring by the stirrer panels, thereby restricting drying and settlement of the stored fluid, and maintaining homogeneity of the fluid. The fluid may be which is selected from a group comprising any or a combination of a colorant, varnish, paint, cleaning fluid, primer, and thinner.

Accordingly, the present disclosure provides an improved and compact pump for tinting machines, which produces a higher flow rate and higher pumping pressure, while occupying less space and reducing the size and manufacturing cost of the pump as well as the tinting machine.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary view of the proposed tinting machine, in accordance with an embodiment of the present disclosure.

FIGS. 2A and 2B illustrate exemplary views of the pump used in the proposed tinting machine in accordance with an embodiment of the present disclosure.

FIG. 2C illustrates an exemplary view of the D45 pump geometry configuration in the pump in accordance with an embodiment of the present disclosure.

FIGS. 3A and 3B illustrate an exemplary view of the canister and stirrer assembly in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some additional effort.

Embodiments of this disclosure relate to an improved and compact pump for tinting machines, which produces a higher flow rate and higher pumping pressure while occupying less space and reducing the size and manufacturing cost of the pump as well as the tinting machine.

According to an aspect, the present disclosure elaborates upon a tinting machine for fluid dispensing. The tinting machine can have one or more pumps in fluid communication with each of the canisters. The canisters can be configured to store fluid within them. The pump can have housing with an inlet port and an outlet port, where the inlet port is fluidically connected to the outlet port of the canister. The pump can further have a stator configured with the housing where a rotor is rotatably configured within the stator. The rotation of the rotor within the stator can enable the inflow of the fluid from the canister into the pump and can further enable the dispensing of fluid through the outlet port. The stator and rotor can be in a D45 geometry configuration such that cavities are formed between the stator and rotor. The cavities enable the inflow of the fluid from the canister into the pump and can further enable the dispensing of the fluid through the outlet port.

In an embodiment, in the D45 geometry configuration, the rotor can have a helical eccentric shape and an elliptical cross-section. The stator can have an internal thread with 120 degrees interval triple starts and 1.5 times pitch, which may create a two/three ratio lobe geometry, resulting in cavities between the rotor and stator.

In an embodiment, the machine can have a stepper motor operatively coupled to the rotor of each of the pumps. The stepper motor can be configured to rotate the rotor within the stator, resulting in dispensing of the fluid from the corresponding pump.

In an embodiment, the stepper motor can be connected to each of the pumps through a coupling assembly. The coupling assembly can have a set of couplings and a coupling disc configured between the rotor and the seal. The coupling assembly can further have a washer and a bottom coupling with a flange configured between the seal and the stepper motor.

In an embodiment, the machine can have a seal between the connecting region of the rotor and the housing of the pump, which allows rotation of the rotor and restricts leakage of the fluid from the housing,

In an embodiment, the machine can have a stirrer assembly configured with each of the canisters. The stirrer assembly can have a set of stirrer panels connected to a longitudinal member extending within the canister to be operated by a stirring motor which upon actuation enables the stirrer panels to stir the fluid stored within the canister, thereby restricting drying and settlement of the stored fluid, and maintaining homogeneity of the fluid.

In an embodiment, the machine can have a fluid selected from a group comprising any or a combination of a colorant, varnish, paint, cleaning fluid, primer, and thinner.

In an embodiment, the machine can have a dispensing tube attached to a nozzle on each of the outlet ports of the pump.

In an embodiment, the machine can have a control unit operatively coupled to the stepper motor associated with each of the pumps. The control unit can be configured to enable controlled and independent actuation of each of the stepper motors or each of the pumps, which can result in dispensing of a predefined amount of the fluid from the outlet port of the corresponding pumps.

In an embodiment, the machine can have a frame enclosed by a second housing. The frame can be adapted to accommodate and hold any or a combination of the control unit, the one or more pumps and the corresponding stepper motors, the one or more canisters, and a platform for holding a container to be filed with a combination of the dispensed fluid.

In an embodiment, the machine can have sensors configured at the platform and coupled to the control unit. The sensors can be configured to detect the placement of the container on the platform.

In an embodiment, the machine can have an SMPS electrically coupled to the stirrer pumps, the stepper motors, the control unit, and the sensors.

In an embodiment, the machine can have an Autocap configured with the nozzle to cover the dispensing head of the nozzle, and restrict drying of the nozzle to keep the nozzle head humidified.

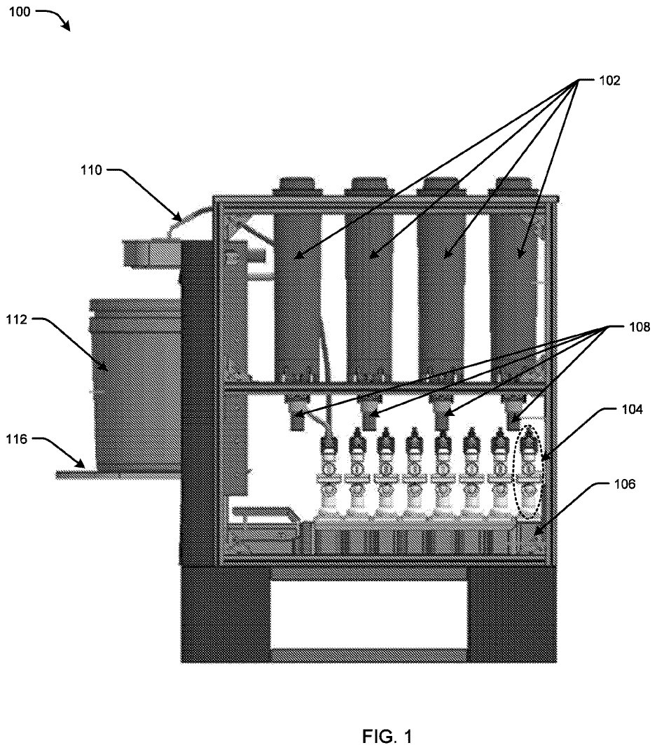

Referring to FIG. 1, the proposed tinting machine (100) can include a pump assembly (104) including multiple pumps (also designated as pump 104, herein) configured with a canister assembly (102) including multiple canisters (also designated as canister 102, herein), Each pump (104) can be configured to dispense fluid through a dispensing tube (110) fitted with a nozzle (114), which can be connected to an outlet port of the pump (104). The canisters (102) can be configured to store different fluids such as but not limited to colorant, varnish, paint, cleaning fluid, primer, and thinner. The machine (100) includes a platform (116) adapted to accommodate a can base (112) thereover below the dispensing tube (110). The can base (112) can be pre-filled with a white base. The machine (100) can include a stepper motor (106) connected to each pump (104), which enables one or more pumps (104) to dispense a predefined amount of the fluid stored in the corresponding canisters (102), into the can base (112) through the dispensing tube (110), which then mixes with the white base in the can base (110) to provide a paint of the desired colour. In an exemplary embodiment, the canisters (104), the platform (116), and the outer enclosing of the machine (100) can be made from polymer, stainless polypropylene or acetal resin materials, and the like.

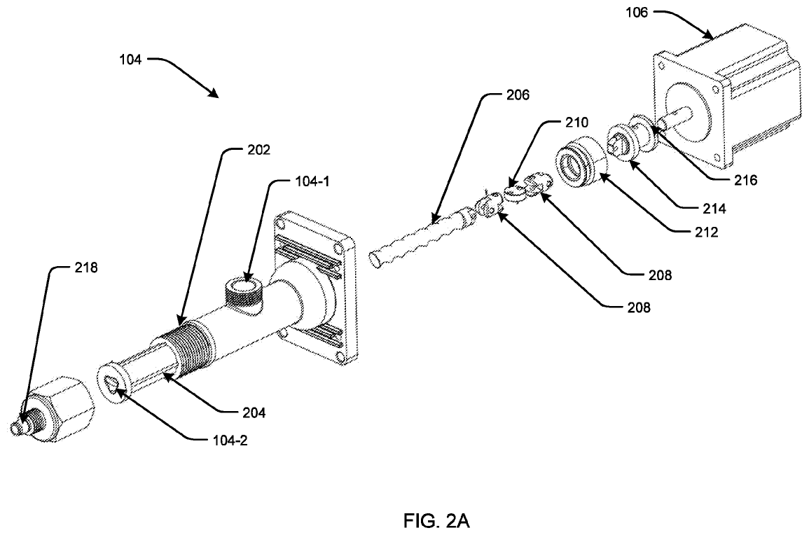

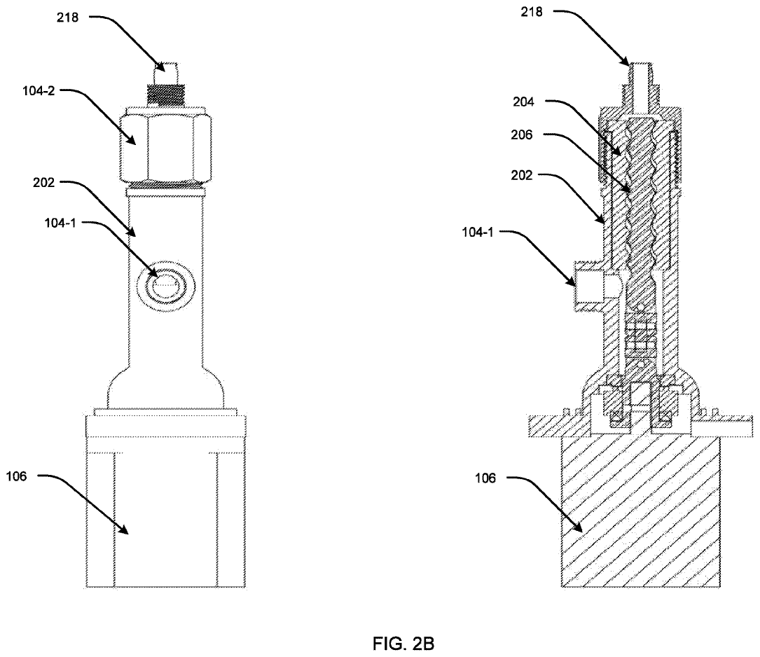

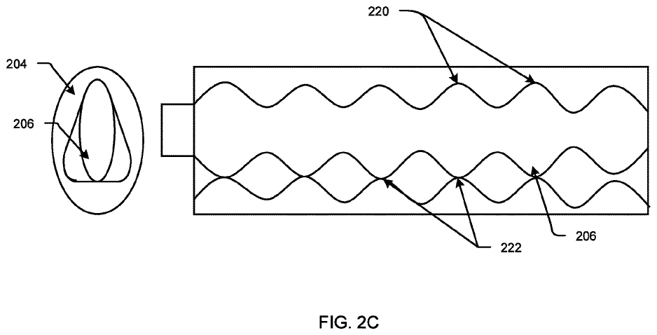

Referring to FIGS. 2A and 2B, the pump (104) can be a D45 pump (104) used in the proposed machine (100), which can include a housing (202) having an inlet port (104-1) and an output port (104-2). The pump (104) includes a stator (204) and a rotor (206) movably configured in the stator (204) such that cavities are formed between the stator (204) and the rotor (206). The stator (204) can be made of metal tubes with moulded cavities of natural or synthetic rubber. The rotation of the rotor (206) within the stator (204) can enable the inflow of the fluid from the canister into the pump (104), dispensing the fluid through the output port (104-2). The output port (104-2) can have an L-shaped nozzle or straight nozzle (218) attached to it. The stepper motor (106) can be operatively coupled to the rotor (206) of the pump (104). The stator and rotor can have a D45 geometry configuration.

Referring to FIG. 2C, the D45 pump geometry configuration of the stator (204) and rotor (206) is disclosed. The stator (204) and rotor (206) can have a stator pitch (220) and a rotor pitch (222), respectively, as shown. As the rotor (206) rotates within the stator (202), an increase in pressure at the output port (104-2) can create an inflow of fluid into the output port (104-2). As the rotor (206) rotates eccentrically in the stator (202), a series of sealed cavities can progress from the suction to the discharge end of the pump (104). Further, as one cavity diminishes, the other cavity increases at the same rate, which keeps the fluid at a flow rate directly proportional to the rotational speed. The pressure capability of the pump (104) is the number so seals formed between the stator (204) and the rotor (206) or number of stages within the pump (104). The stage of the proposed D45 pump can be designed to be 1.5 times the pitch length of the stator (202) or 3 times the pitch length of the rotor (206). This configuration produces an extra discharge channel providing a 50 percent increase in flow rate. As a result, of this two/three ratio lobe geometry, cavities can be formed between the stator (202) and rotor (206) to ensure a proper seal between the stator (202) and the rotor (206). Correspondingly, the performance of the pump (104) is improved due to more number of seal lines or stages.

Generally, as the pressure increases for a given number of stages, the flow rate decreases, which is known as slip. The slip can be dependent upon the number of stages, the viscosity of the fluid being pumped, and the compression fit between the stator (202) and the rotor (206). The cavities in the proposed D45 geometry-based pump (104) can be about 70 percent of the size compared to existing S or L geometries-based pumps, but the cavities of the proposed D45 pump (104) pass twice per rotation instead of only once, resulting in a 50 percent higher flow rate compared to existing S or L geometry-based pumps.

Besides, the two-stage D45 pump can reach differential pressures up to 12 bar at a flow rate 150 percent over that of an S geometry pump (104). The D45 geometry pump can have two/three ratio lobe geometry with compact dimensions despite high pressures and flow rates. Further, the D45 pump (104) can produce pulsating free pumping with a high metering accuracy.

In an exemplary embodiment, the stator (204) can be made from an elastomer. The stator (204) can consist of a steel tube with an elastomer that is bonded to the inside and moulded in the configuration of a double helix. The elastomer can be resistant to oil and solvent, can have improved tensile strength, abrasion resistance, and high-temperature resistance, and can have reduced resilience and permeability qualities. The rotor (206) can be made from alloy steel and chrome plated. The temperature range of this elastomer could be 121 degrees centigrade.

In an embodiment, the D45 pump geometry configuration can have a helical eccentric screw/rotor (206) with an elliptical cross-section, a long pitch, and a large thread depth. The rotor (206) can turn in a circular eccentric motion within the fixed stator (204), which has an internal thread with the same profile as the rotor (206), but with 120 degrees interval triple starts and 1.5 times the pitch. As a result of this two/three ratio lobe geometry, cavities can be formed between the rotor (206) and the stator (204). The progressing cavities between the two transport the fluid in a smooth and continuous manner to the output port (104-1). The cavities in D45 pump are about 75 percent of the size of those in S or L geometry-based pumps, but the cavities in D45 pump are passed through twice per revolution instead of only once, resulting in a 50 percent higher flow rate. With the increasing number of lobes, the flow can be repeated within a single revolution where the numbers of cycles are equal to the number of lobes. Increasing the number of lobes can reduce the fluctuation in the flow rate, hence a lower pulsating performance of the pump (104). The two/three ratio lobe geometry can offer the same flow rate with one/two lobe geometry at half the rotational speed, thereby reducing the wear and maintenance cost of the pump (104).

In an exemplary embodiment, the performance of the rotor (206) can be monitored using a magnetic field sensor and a computer system. The magnetic field sensor can be positioned on the rotor (206) and the rotation speed may be determined by determining the frequency of the largest magnetic field reading or using amplitude readings from the magnetic field sensor. The computer system can be configured to determine more complex characteristics, for example, to determine if the rotor (206) is sticking for any amount of time by measuring phase changes in the waveform. A pressure sensor, temperature sensor, and accelerometer can be configured to monitor the performance of the pump (104). A universal pin joint can be used in the pump (104) as a coupling arrangement between the drive shaft and the rotor (206).

In an exemplary embodiment, a processor can be operably coupled to the pump (104) and a computer system. The processor can be configured to regulate the speed of the pump (104) for optimized production of the fluid. The processor can monitor the speed differences using a speed sensor configured on the pump (104) and compare it to a pre-set value using feedback control loop indicating a belt slippage issue.

The operation of the pump (104) can be controlled and automated through a control unit, which can actuate the stepper motor (106) to enable the operation of the pump (104). The pump (104) can have a set of couplings (208) and a coupling disc (210) configured between the rotor (206) and a seal (212), where the coupling disc (210) is between the couplings (208). Further, a washer (214) and a bottom coupling with flange (216) can be configured between the seal (212) and the stepper motor (106). In an embodiment, the seal (212) can be a mechanical seal or any other type of seal available in the art, and all such embodiments are well within the scope of the present disclosure.

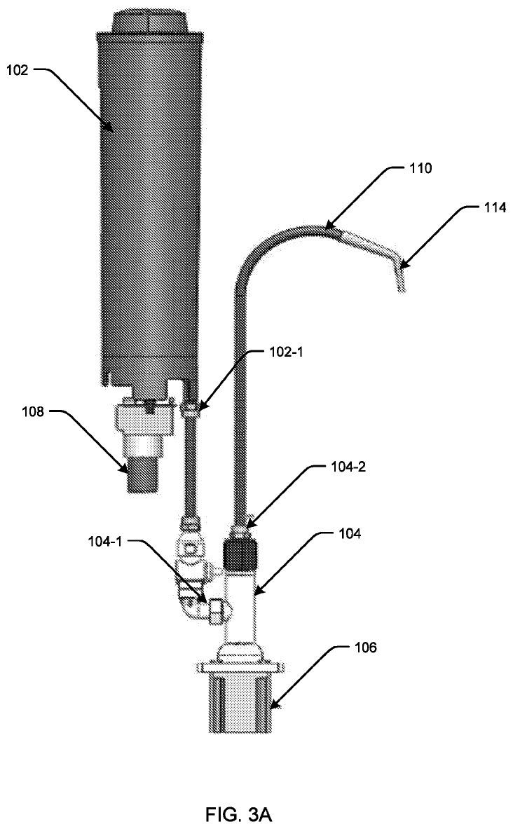

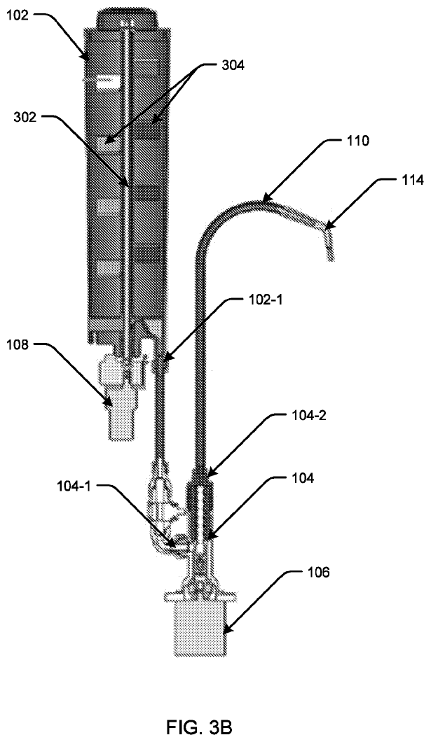

Referring to FIGS. 3A and 3B, each of the canisters (102) can be configured with a stirrer assembly. The stirrer assembly can include a set of stirrer panels (304) connected to a longitudinal member (302) extending within the canister (102) as shown in FIG. 3B. Further, a stirring motor (108) can be operatively coupled to the longitudinal member (302) and the set of stirrer panels (304) such that the actuation of the stirrer motor (108) enables the stirrer panels (304) to rotate about their axis and stir the fluid stored within the canister (102), thereby restricting drying and settlement of the stored fluid, and maintaining homogeneity of the fluid. Further, the outlet (102-1) of the canister (102) can be connected to the inlet port (104-1) of the pump (104) and the outlet port (104-1) of the pump (104) can be connected to the dispensing tube (110) fitted with a nozzle (114).

In an embodiment, the pump (104) can be configured to dispense fluid from the corresponding canister (102) upon getting a command from the control unit that can be operatively coupled to the stepper motor associated with each of the pumps (104), and the stirrer pump (108). The control unit can be configured to enable a controlled and independent actuation of each of the stepper motors (106) or each of the pumps (104), which may result in automated dispensing of a predefined amount of the fluid from the output port (104-2) of the pumps (104) into the can base (112).

In an exemplary embodiment, a pressure monitoring system can be incorporated with the pump (104). Protection against over pressure and under pressure can protect the pump (104) from unsuitable pressures, increasing the reliability and reducing the downtime of the pump (104). A multi-functional pressure instrument with a diaphragm pressure gauge and a pressure control device can be used together as a pressure monitoring system.

In an embodiment, the fluid dispensing command can be provided through a mobile communication device, personal computer to a logic board. The logic board can be configured to check the fluid as per the formulation. Based on the availability of the fluid an Autocap can be configured with the nozzle (114) to cover the dispensing head of the nozzle (114), and restrict drying of the nozzle (114) to keep the nozzle head humidified. An alarm can be provided in the absence of the can base or container on the platform (116).

In an exemplary embodiment, the stepper motor (106) used can be a 5 volt bipolar stepper motor with an L293D motor driver with an AT89C51 control unit. The command from the personal computer can be updated to a cloud database to be analyzed for efficiency. The machine (100) can include a set of sensors configured at the platform (116) and operatively coupled to the control unit, where the sensors can be configured to detect the placement of the can base (112) on the platform (116). Further, the machine (100) can include an SMPS or a power supply unit electrically coupled to the stirrer pumps (108), the stepper motors (106), the control unit, and the sensors.

Accordingly, the present disclosure provides an improved and compact pump for tinting machines, which produces a higher flow rate and higher pumping pressure, while occupying less space and reducing the size and manufacturing cost of the pump as well as the tinting machine.

It is to be appreciated by a person skilled in the art that while various embodiments of the present disclosure have been elaborated for tinting machine (100) dispensing colorants, however, the teachings of the present disclosure are also applicable for other types of fluids as well, and all such embodiments are well within the scope of the present disclosure. Further, while various embodiments of the present disclosure have been elaborated for the pump (104) being used in a tinting machine (100), however, the proposed pump (104) with the D45 pump geometry configuration is also equally implementable in other industries as well, and all such embodiments are well within the scope of the present disclosure without any limitation. Furthermore, while various embodiments of the present disclosure have been elaborated for the seal (212) being a mechanical seal, however, other types of seals known in the art are also equally implementable in the proposed pump (104), and all such embodiments are well within the scope of the present disclosure without any limitation.

Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

While the foregoing describes various embodiments of the disclosure, other and further embodiments of the disclosure may be devised without departing from the basic scope thereof. The scope of the disclosure is determined by the claims that follow. The invention is not limited to the described embodiments, versions or examples, which are included to enable a person having ordinary skill in the art to make and use the disclosure when combined with information and knowledge available to the person having ordinary skill in the art.

### ADVANTAGES OF THE INVENTION

The proposed invention overcomes the above drawback, limitations, and shortcomings associated with existing S and L-type geometry pumps.

The proposed invention reduces the size of pumps used in tinting machines, without compromising the overall performance of the pump and the tinting machine.

The proposed invention provides a pump geometry configuration that produces a higher flow rate and higher pumping pressure and has higher accuracy while dispensing fluids, ensuring efficient operation.

The proposed invention provides a pump geometry configuration that reduces the overall size and manufacturing cost of the pump as well as the tinting machine.

The proposed invention provides an improved and compact pump for tinting machines, which produces a higher flow rate and higher pumping pressure while occupying less space and reducing the size and manufacturing cost of the pump as well as the tinting machine.

1. A tinting machine (100) comprising:
one or more pumps (104) fluidically coupled to one or more canisters (102), such that there being one pump (104) fluidically coupled to one of the canisters (102), each of the canisters (102) adapted to store fluid therewithin, wherein each of the pump (104) comprises:
a housing (202) comprising an inlet port (104-1) and an outlet port (104-2), wherein the inlet port (104-1) is fluidically connected to an outlet of the corresponding canister (102);
a stator (204) configured with the housing (202); and
a rotor (206) rotatably configured within the stator (204), wherein the stator (204) and rotor (206) are in a D45 geometry such that cavities are formed between the stator (204) and rotor (206), and the rotor (206) rotates in a circular eccentric motion within the stator (204), which allows the cavities to enable inflow of the fluid from the canister into the pump (104) and further enables dispensing of the fluid through the outlet port (104-2).

2. The tinting machine (100) as claimed in claim 1, wherein the D45 geometry comprises the rotor (206) having a helical eccentric shape and an elliptical cross-section, and the stator (204) having an internal thread with 120 degrees interval triple starts and 1.5 times pitch, thereby creating a two/three ratio lobe geometry, which creates the cavities between the rotor (206) and stator (204).

3. The tinting machine (100) as claimed in claim 1, wherein the machine (100) comprises a stepper motor (106) operatively coupled to the rotor (206) of each of the pumps (104) and configured to rotate the rotor (206) within the stator (204), resulting in dispensing of the fluid from the corresponding pump (104).

4. The tinting machine (100) as claimed in claim 2, wherein the stepper motor (106) is operatively coupled to the rotor (206) through a coupling assembly comprising: a set of couplings and a coupling disc (210) configured between the rotor (206) and a seal (212); and a washer (214) and a bottom coupling with flange (216) configured between the seal (212) and the stepper motor (106).

5. The tinting machine (100) as claimed in claim 1, wherein a seal is configured at a connecting region between the rotor (206) and the housing (202) of the pump (104), which allows rotation of the rotor (206) and restricts leakage of the fluid from the housing (202).

6. The tinting machine (100) as claimed in claim 1, wherein the machine (100) comprises a stirrer assembly configured with each of the canisters (102), wherein the stirrer assembly comprises: a set of stirrer panels (304) connected to a longitudinal member (302) extending within the canister (102); and a stirring motor (108) operatively coupled to the longitudinal member (302) and the set of stirrer panels (304), which upon actuation enables the stirrer panels (304) to stir the fluid stored within the canister (102), thereby restricting drying and settlement of the stored fluid, and maintaining homogeneity of the fluid.

7. The tinting machine (100) as claimed in claim 1, wherein the fluid is selected from a group comprising any or a combination of a colorant, varnish, paint, cleaning fluid, primer, and thinner.

8. The tinting machine (100) as claimed in claim 1, wherein the output port (104-2) of each of the pumps (104) is configured with a dispensing tube (110) having a nozzle (114) attached thereto.

9. The tinting machine (100) as claimed in claim 1, wherein the machine (100) comprises a control unit operatively coupled to the stepper motor (106) associated with each of the pumps (104), the control unit configured to enable controlled and independent actuation of each of the stepper motors (106) or each of the pumps (104), which results in dispensing of a predefined amount of the fluid from the output port (104-2) of the corresponding pumps.

10. The tinting machine (100) as claimed in claim 1, wherein the machine (100) comprises a frame enclosed by a second housing, the frame adapted to accommodate and hold any or a combination of the control unit, the one or more pumps (104) and the corresponding stepper motors (106), the one or more canisters (102), and a platform (116) for holding a container (112) to be filed with a combination of the dispensed fluid.
